(19) United States
(12) Patent Application Publication
(10) Pub. No.: US 2022/0256780 A1
(43) Pub. Date: Aug. 18, 2022

(54) Spliced Tree Skirt

(71) Applicant: NINGBO FLYING-HORSE INTERNATIONAL TRADE CO., LTD, Ningbo (CN)

(72) Inventor: Honghua Zhao, Ningbo (CN)

(73) Assignee: NINGBO FLYING-HORSE INTERNATIONAL TRADE CO., LTD, Ningbo (CN)

(21) Appl. No.: 17/739,219

(22) Filed: May 9, 2022

(30) Foreign Application Priority Data
Jan. 28, 2022 (CN) 202220243618.0

(51) Int. Cl. A01G 13/02; A47G 33/04; F16B 5/07

(52) U.S. Cl. CPC A01G 13/0237; F16B 5/07; A47G 33/04

(57) ABSTRACT

A spliced tree skirt is disclosed in the present invention, which is formed by connecting a plurality of tree skirt members to each other, and further includes a connecting assembly. The connecting assembly includes a first connecting member and a second connecting member. The tree skirt members each include a first surface and a second connecting member, and the first connecting member or the second connecting member is arranged on the first surface or the second surface, so as to form a tree skirt that is spliced by lapping end to end sequentially or fitting sequentially. The spliced tree skirt of the present invention is assembled from a plurality of tree skirt members of substantially the same size, which is small in size in a disassembled state, easy to package and transport, and has a good visual appearance and function after assembly.

### TECHNICAL FIELD

The present invention belongs to the field of festival decoration articles, and in particular, relates to a tree skirt used for decorating a Christmas tree.

### BACKGROUND

Christmas is a traditional festival in many countries in Europe and America, and a Christmas trees are essential during decorations for Christmas. In the above countries, many places such as homes, hotels, shopping malls, offices, and specialty stores will make festival decorations before Christmas. Christmas tree skirts are also often used, which are used for surrounding the Christmas trees for decoration.

Traditionally used Christmas tree skirts are mostly integrally formed Christmas tree skirts or cloth tree skirts. The former has a fixed structure and cannot be disassembled, which not only takes up space and causes inconvenience during transportation, but also easily damages the tree skirt. The latter is poor in moldability.

### SUMMARY

An objective of this embodiment is to provide a tree skirt assembled by using a spliced structure. Tree skirt members are of a sheet-like structure, which is convenient for packaging and transportation, and can form a stable and beautiful Christmas tree skirt after assembly.

For achieving the above objective, a solution adopted in the present invention is:

a spliced tree skirt including a plurality of tree skirt members, the tree skirt members being connected to each other to form the spliced tree skirt.

The spliced tree skirt further includes a connecting assembly, the connecting assembly including a first connecting member and a second connecting member.

The tree skirt members each include a first surface and a second surface, the first connecting member is arranged on the first surface, and the second connecting member is arranged on the second surface, and the tree skirt members are arranged end to end so that the first connecting member of the previous tree skirt member fits the second connecting member of the succeeding tree skirt member.

A spliced tree skirt includes a plurality of tree skirt members, the tree skirt members include a first tree skirt member and a second tree skirt member, there are a plurality of first tree skirt members and a plurality of second tree skirt members, respectively, and the first tree skirt members and the second tree skirt members are arranged to be spaced apart from each other.

The spliced tree skirt further includes a connecting assembly, the connecting assembly including a first connecting member and a second connecting member.

The first tree skirt member and the second tree skirt member each include a first surface and a second surface, the first surface of the first tree skirt member is provided with the first connecting member and the second connecting member, the second surface of the second tree skirt member is provided with the first connecting member and the second connecting member, and the tree skirt members are arranged end to end, so that the first connecting member of the previous tree skirt member fits the second connecting member of the succeeding tree skirt member.

According to the above spliced tree skirt, the tree skirt members each include a support member, and the support members are preferably plastic members or metal members made of a rigid material that is bendable and deformable, so that the tree skirt members are sheet shaped before splicing and form a stable shape after splicing to serve as a tree skirt.

According to the above spliced tree skirt, the tree skirt member is sheet shaped, which is a plastic sheet or a metal sheet, and has a thickness of 0.1 mm to 5 mm.

According to the above spliced tree skirt, a cross-sectional shape of the tree skirt member is a trapezoid or a fan shape.

According to the above spliced tree skirt, there are two first connecting members and two second connecting members respectively, which are correspondingly arranged on upper and lower portions of a side edge of the tree skirt member.

According to the above spliced tree skirt, the first connecting members and the second connecting members are arranged on an inner side of the side edge of the tree skirt member, and the tree skirt members are spliced to each other to form a lap area with a certain width.

According to the above spliced tree skirt, the tree skirt member is provided with a lap member protruding with respect to the side edge thereof, and the first connecting members or the second connecting members are arranged on the lap member.

According to the above spliced tree skirt, the tree skirt member further comprises a cladding layer arranged on at least one side of the tree skirt member.

According to the above spliced tree skirt, the cladding layer is made of a leather material, and there are two cladding layers respectively arranged on both sides of the support member, and the area of the cladding layer is greater than that of the support member, so as to completely wrap an edge of the support member.

According to the above spliced tree skirt, the connecting assembly includes sewing buttons, magnetic buttons, or HOOK & LOOP.

The spliced tree skirt of the present invention assembles a plurality of tree skirt members to form a complete tree skirt, and the tree skirt members fit each other end to end. The assembling method includes lapping identical tree skirt members in the same direction, and further includes connecting different tree skirt members oppositely in sequence at intervals to form the spliced tree skirt.

When the tree skirt is packaged, transported, or stored, it can be disassembled into a plurality of sheet-like tree skirt members. During transportation, the tree skirt is flat, which can reduce the volume. However, it can form a truncated cone-shaped tree skirt by elastic deformation with the deformability of itself (material). At the same time, the rigid material itself has certain rigidity, which can support the truncated cone without collapse or deformation. In addition, the assembly is convenient, and the end-to-end connection can also be conveniently performed through the connecting assembly, For example, when sewing buttons are used, the connection may be achieved by pressing and snapping.

In the spliced tree skirt of the present invention, the tree skirts each include a support member made of a rigid material that is bendable and deformable, which can play a supporting role when the tree skirt is assembled, and prevent tree skirt members from collapsing after assembly. By arranging the support member, the tree skirt obtained by assembling can be full in shape and have a moderate structural strength.

In addition, the spliced tree skirt of the present invention further includes a surface cladding layer made of a soft material such as leather, which provides good visual and tactile effects, and can also protect and buffer the support member to avoid damages.

### BRIEF DESCRIPTION OF THE DRAWINGS

FIG. 1 is a schematic diagram of an assembly structure of a spliced tree skirt according to Embodiment 1;

FIG. 2 is a schematic structural diagram of one side of a single tree skirt member according to the embodiment of FIG. 1 and a schematic partial enlarged diagram thereof;

FIG. 3 is a schematic structural diagram of the other side opposite to FIG. 2 and a schematic partial enlarged diagram thereof;

FIG. 4 is a schematic structural exploded diagram of the tree skirt member according to the embodiment of FIG. 1;

FIG. 5 is a schematic structural diagram of a tree skirt member according to Embodiment 2; and

FIG. 6 is a schematic structural diagram of a tree skirt member according to Embodiment 3.

### DESCRIPTION OF THE EMBODIMENTS

In order for those skilled in the art to better understand the present invention and thus to more clearly define the protection scope of the present invention, the present invention will be described in detail below with respect to some specific embodiments of the present invention. It should be noted that the following are only some specific embodiments of the present invention, which are only a part of the embodiments of the present invention, and the specific and direct description of the relevant structures is only for the convenience of understanding the present invention, and specific features do not definitely and directly limit the implementation scope of the present invention. Routine selections and substitutions made by those skilled in the art under the guidance of the concept of the present invention should all be deemed to be within the protection scope of the present invention.

### Embodiment 1

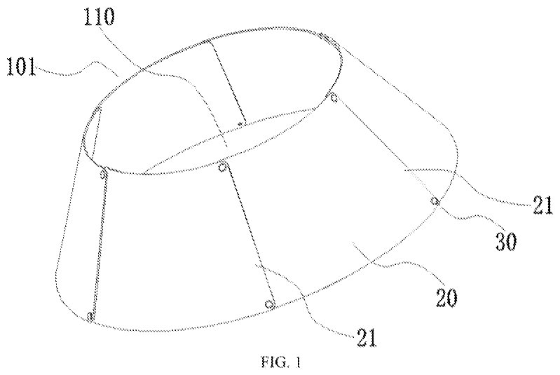

As shown in FIG. 1, a spliced tree skirt is used for festival decorations, especially for Christmas tree decorations.

As shown in FIG. 1, the spliced tree skirt is formed by splicing a plurality of sheet-shaped tree skirt members. The spliced tree skirt is in the shape of a truncated cone as a whole, and its interior is hollow for accommodating a Christmas tree and other decorative members that can be placed at the foot of the Christmas tree. It is not limited whether the spliced tree skirt has a bottom surface. In this embodiment, the tree skirt does not have a bottom surface and is arranged along a side surface of the truncated cone, the interior thereof is formed as an inner cavity 110, and an upper portion thereof is formed as an upper opening 101.

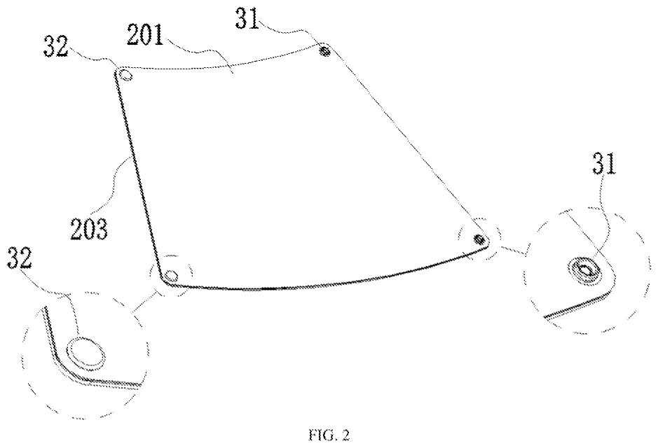

As shown in FIG. 2, the tree skirt members used for forming the tree skirt are sheet-like as a whole, and their thickness is significantly smaller than their length and width.

The tree skirt member has a shape close to a trapezoid, more preferably an isosceles trapezoid. Preferably, the upper bottom and the lower bottom of the trapezoid are curved downwards, respectively, so that upper and lower openings of the tree skirt formed by splicing them are circular rather than polygonal. Such a design, on the one hand, can make the spliced tree skirt more beautiful, and on the other hand, can also avoid the upper bottom or the lower bottom after splicing from overall deformation or loosening of connections caused by a bending force.

As shown in FIG. 2, in this embodiment, a tree skirt member 20 has a first surface 201 and a second surface 202. In a fitted state shown in FIG. 1, the first surface 201 is formed as an outer surface of the spliced tree skirt, and the second surface 202 is formed as an inner surface of the spliced tree skirt.

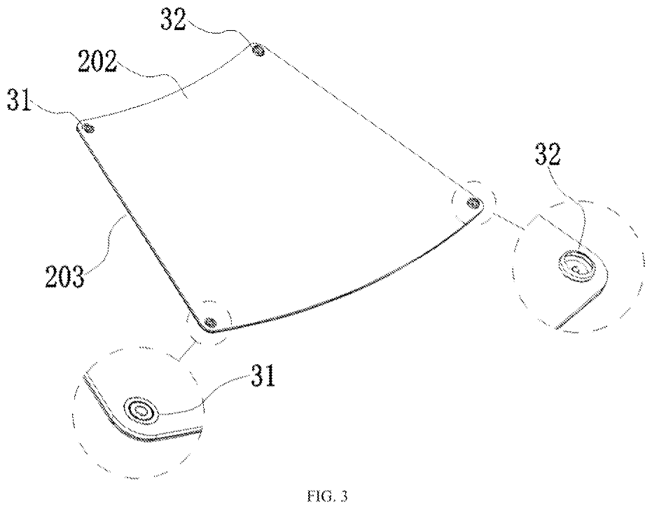

As shown in FIG. 2 and FIG. 3, a plurality of first connecting members 31 are arranged on the tree skirt member 20 on the right side of the first surface 201, and a plurality of second connecting members 32 are provided on the tree skirt member 20 on the left side of the second surface 202, so that the first connecting members 31 and the second connecting members 32 are located on different surfaces of the tree skirt member 20. When the tree skirt members 20 are spliced and assembled with each other, they are connected end to end so as to be interlocked into a spliced state as shown in FIG. 1.

In this embodiment, the first connecting member 31 is a male sewing button, and the second connecting member 32 is a female sewing button, and the two are snapped together for locking or separated from each other for unlocking.

As shown in FIG. 2 and FIG. 3, there are two first connecting members 31 and two second connecting members 32, which are respectively arranged on upper and lower portions of a side edge of the tree skirt member, preferably near top corners.

Of course, the sewing button (also referred to as a snap fastener) is only a structure used for realizing the mutual fitting of the two connecting members in this embodiment, and other known male and female buttons other than sewing buttons can also be used as connecting members, such as HOOK & LOOP, magnetic buttons, or other known connection structures.

In this embodiment, the side edges of the tree skirt members are flat, the first connecting members 31 and the second connecting members 32 are arranged on inner sides of the side edges of the tree skirt members, and the tree skirt members are spliced to each other to form a lap area 21 with a certain width.

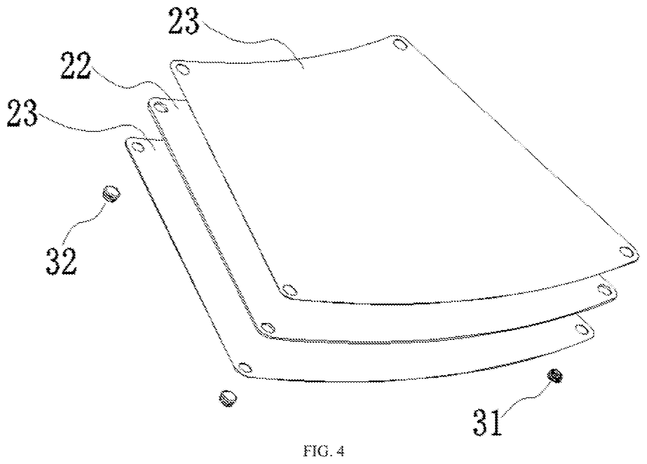

As shown in FIG. 4, the tree skirt member 20 of this embodiment is composed of a support member 22 and two cladding layers 23 located on both sides of the support member 22. The support member 22 is made of a rigid material (such as plastic or metal) that is bendable and deformable, which can be deformed and can play a supporting role. The cladding layer 23 is made of a soft material, such as leather and a covering film, and functions to play a visual decoration or to protect or buffer the support member. Due to material properties of the support member 22, its visual appearance, anti-collision, and scratch resistance performances are often unsatisfactory, or achievable but expensive; therefore, the cladding layer 23 can improve the visual appearance and protect the support member.

This embodiment shows an example in which both sides of the support member 22 are provided with the cladding layer 23; however, for cost and process considerations, omitting one or both of them does not technically affect the application of the spliced tree skirt.

In this embodiment, the support member 22 may be made of a rigid material that is bendable and deformable such as PVC, for example, a plastic sheet or a metal sheet (including a metal mesh sheet) with a thickness of 0.1 mm to 5 mm, and its surface may also be formed with longitudinal or oblique ribs for increasing the support strength of the tree skirt members during assembling and reducing the thickness of the support member, so that the support member 22 has certain elasticity and rigidity at the same time, so as to form a stable structure during splicing to avoid collapsing, and the tree skirt formed by splicing also has suitable structural strength.

In this embodiment, FIG. 4 shows an embodiment in which both sides of the support member 22 are respectively provided with the cladding layers 23, and the two are substantially equal in size. However, it is preferred to arrange the cladding layer 23 to be greater than the size of the support member 22. That is, a middle body of the tree skirt member 20 has a three-layer structure, and the two cladding layers 23 are directly connected within a small width of the edge. Without affecting the overall strength of the tree skirt member, the support member 22 can be wrapped and protected better, and the connections between the support member 22 and the cladding layers 23 can also be prevented from being separated.

### Embodiment 2

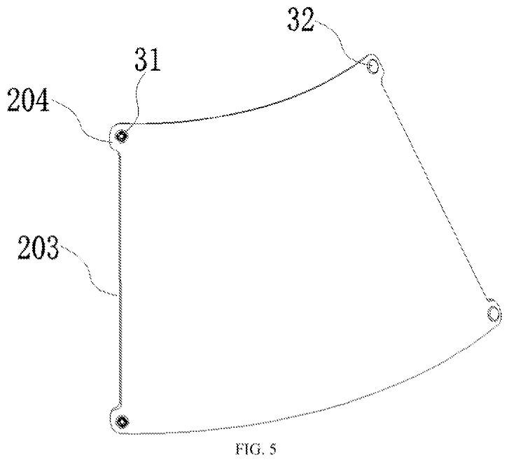

As shown in FIG. 5, a main structure of a spliced tree skirt is the same as that of the Embodiment 1, and a difference is that the tree skirt member 20 of this embodiment is provided with a lap member 204 arranged to protrude with respect to a side edge 203 thereof, and the first connecting member 31 or the second connecting member 32 is arranged on the lap member 204.

### Embodiment 3

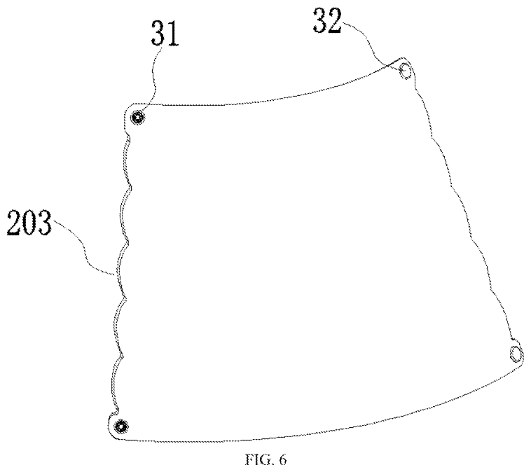

A spliced tree skirt has a main structure the same as that of Embodiment 1, and a difference is that at least one side edge 203 of the tree skirt member 20 in this embodiment is further provided with a modeling portion, and the shape or pattern of the modeling portion may be set as required. For example, the side edge 203 as shown in FIG. 6 is arranged in a wavy shape.

### Embodiment 4

A spliced tree skirt has a main structure the same as that of Embodiment 1, and a difference is that in the embodiment, the tree skirt members 20 are classified into first tree skirt members and second tree skirt members due to different setting positions of the first connecting member 31 and the second connecting member 32. Other structures of the first tree skirt member and the second tree skirt member may be the same.

In this embodiment, the first connecting member 31 and the second connecting member 32 of the first tree skirt member arc both arranged on the first surface thereof, while the first connecting member 31 and the second connecting member 32 of the second tree skirt member arc both arranged on the second surface thereof. During assembly, the first tree skirt members and the second tree skirt members are arranged to be spaced apart, so that the first connecting member 31 of the previous tree skirt member fits the second connecting member 32 of the succeeding tree skirt member, so that the second connecting member 32 of the first tree skirt member fits the first connecting member 31 of the next second tree skirt member, and the second connecting member 32 of the second tree skirt member fits the first connecting member 31 of the next first tree skirt member, thus forming the spliced tree skirt of this embodiment.

What is claimed is:

1. A spliced tree skirt, comprising:
a plurality of tree skirt members, the tree skirt members being connected to each other to form the spliced tree skirt; and
a connecting assembly, the connecting assembly comprising a first connecting member and a second connecting member, wherein
the tree skirt members each comprise a first surface and a second surface, the first connecting member is arranged on the first surface, and the second connecting member is arranged on the second surface; and
the tree skirt members are arranged end to end so that the first connecting member of the previous tree skirt member fits the second connecting member of the succeeding tree skirt member.

2. The spliced tree skirt according to claim 1, wherein the tree skirt members each comprise a support member, and the support members are made of a rigid material that is bendable and deformable, so that the tree skirt members are sheet shaped before splicing and form a stable shape after splicing.

3. The spliced tree skirt according to claim 2, wherein the tree skirt member is sheet shaped, which is a plastic sheet or a metal sheet, and has a thickness of 0.1 mm to 5 mm.

4. The spliced tree skirt according to claim 2, wherein a cross-sectional shape of the tree skirt member is a trapezoid or a fan shape.

5. The spliced tree skirt according to claim 4, wherein there are two first connecting members and two second connecting members respectively, which are correspondingly arranged on upper and lower portions of a side edge of the tree skirt member.

6. The spliced tree skirt according to claim 5, wherein the first connecting members and the second connecting members are arranged on an inner side of the side edge of the tree skirt member, and the tree skirt members are spliced to each other to form a lap area with a certain width; or, the tree skirt member is provided with a lap member protruding with respect to the side edge thereof, and the first connecting members or the second connecting members are arranged on the lap member.

7. The spliced tree skirt according to claim 2, wherein the tree skirt member further comprises a cladding layer arranged on at least one side of the tree skirt member.

8. The spliced tree skirt according to claim 7, wherein the cladding layer is made of a leather material, and there are two cladding layers respectively arranged on both sides of the support member.

9. The spliced tree skirt according to claim 8, wherein the area of the cladding layer is greater than that of the support member, so as to completely wrap an edge of the support member.

10. The spliced tree skirt according to claim 1, wherein the connecting assembly comprises sewing buttons, magnetic buttons, or HOOK & LOOP.

11. A spliced tree skirt, comprising:
a first tree skirt member,
a second tree skirt member, wherein there are a plurality of first tree skirt members and a plurality of second tree skirt members, respectively, and the first tree skirt members and the second tree skirt members are arranged to be spaced apart from each other; and
a connecting assembly, the connecting assembly comprising a first connecting member and a second connecting member, wherein
the first tree skirt member and the second tree skirt member each comprise a first surface and a second surface, the first surface of the first tree skirt member is provided with the first connecting member and the second connecting member, the second surface of the second tree skirt member is provided with the first connecting member and the second connecting member, and the first tree skirt members and the second tree skirt members are arranged end to end, so that the second connecting member of the first tree skirt member fits the first connecting member of the second tree skirt member, and the second connecting member of the second tree skirt member fits the first connecting member of the first tree skirt member.

12. The spliced tree skirt according to claim 11, wherein the tree skirt members or the second tree skirt members each comprise a support member, and the support member is made of a rigid material that is bendable and deformable, so that the first tree skirt members or the second tree skirt members are sheet shaped before splicing and form a stable shape after splicing.

13. The spliced tree skirt according to claim 12, wherein the first tree skirt member or the second tree skirt member is sheet shaped, which is a plastic sheet or a metal sheet, and has a thickness of 0.1 mm to 5 mm.

14. The spliced tree skirt according to claim 12, wherein a cross-sectional shape of the first tree skirt member or the second tree skirt member is a trapezoid or a fan shape.

15. The spliced tree skirt according to claim 14, wherein there are two first connecting members and two second connecting members respectively, which are correspondingly arranged on upper and lower portions of a side edge of the first tree skirt member or the second tree skirt member.

16. The spliced tree skirt according to claim 15, wherein the first connecting members and the second connecting members are arranged on an inner side of the side edge of the first tree skirt member or the second tree skirt member, and the first tree skirt member and the second tree skirt member are spliced to each other to form a lap area with a certain width; or, the first tree skirt member or the second tree skirt member is provided with a lap member protruding with respect to the side edge thereof, and the first connecting members or the second connecting members are arranged on the lap member.

17. The spliced tree skirt according to claim 12, wherein the first tree skirt member or the second tree skirt member further comprises a cladding layer arranged on at least one side of the first tree skirt member or the second tree skirt member

18. The spliced tree skirt according to claim 17, wherein the cladding layer is made of a leather material, and there are two cladding layers respectively arranged on both sides of the support member.

19. The spliced tree skirt according to claim 18, wherein the area of the cladding layer is greater than that of the support member, so as to completely wrap an edge of the support member.

20. The spliced tree skirt according to claim 1, wherein the connecting assembly comprises sewing buttons, magnetic buttons, or HOOK & LOOP.
